(19) United States
(12) Patent Application Publication
(10) Pub. No.: US 2014/0362155 A1
(43) Pub. Date: Dec. 11, 2014

(54) ENVIRONMENTAL PROTECTION SUPPORTING APPARATUS AND METHOD

(71) Applicants: KABUSHIKI KAISHA TOSHIBA, TOKYO (JP); TOSHIBA TEC KABUSHIKI KAISHA, TOKYO (JP)

(72) Inventor: Akihiro Mizutani, Mishima-shi (JP)

(73) Assignees: KABUSHIKI KAISHA TOSHIBA, TOKYO (JP); TOSHIBA TEC KABUSHIKI KAISHA, TOKYO (JP)

(21) Appl. No.: 14/295,519

(22) Filed: Jun. 4, 2014

(30) Foreign Application Priority Data
Jun. 6, 2013 (JP) 2013-119403

(51) Int. Cl. B41J 29/38

(52) U.S. Cl. CPC B41J 29/38
USPC 347/179

(57) ABSTRACT

An environmental protection supporting apparatus comprises a storage section configured to store, based on the result of an erasing processing of heating a recording medium on which an image is formed with a color erasable coloring agent to erase the image formed thereon, the erasing log of the recording medium which is at least determined as reusable; a rejection information generation section configured to generate, based on the erasing log, rejection information obtained from the rejection of the reusable recording medium as environmental load reduction information; and a presenting section configured to display the environmental load reduction information on a display section.

### CROSS-REFERENCE TO RELATED APPLICATION

This application is based upon and claims the benefit of priority from Japanese Patent Application No. 2013-119403, filed Jun. 6, 2013, the entire contents of which are incorporated herein by reference.

### FIELD

Embodiments described herein relate to an environmental protection supporting apparatus which erases the image formed with an image forming apparatus on a paper using an erasing apparatus to reuse the paper so as to support environmental protection in, for example, an office and informs the user of the rejection information of paper which are not reusable and to be rejected and a supporting method.

### BACKGROUND

As an example of the environmental protection in, for example, an office, there is a way of paper saving. In addition to decreasing printing itself, erasing (decolorizing) the image printed on a paper to recycle (reuse) the paper is also effective in paper saving. Conventionally, an image is formed on a paper by an image forming apparatus such as a MEP (Multi Function Peripheral) with a color erasable coloring agent such as ink containing leuco dye so that the paper can be reused after the image, when not needed any more, is erased by an erasing apparatus.

As a color erasable coloring agent is erased when heated to a high temperature, to reuse a paper, the paper is heated by an erasing apparatus to erase the image formed thereon. In the erasing apparatus, a platen roller and a heat source are oppositely arranged across a paper conveyance path, and a paper is conveyed and heated between the platen roller and the heat source, thereby erasing a color erasable coloring agent. The aforementioned erasing of an image formed on a paper is hereinafter referred to as ‘color erasing’.

The reuse of paper saves paper and is beneficial to environmental protection. In addition, generally, there is known an environmental protection supporting method according to which the user of a MFP is informed of a paper purchase cost and a paper storage cost or the number of reused paper to be strengthened in the cost awareness and environmental protection awareness (e.g. Japanese Unexamined Patent Application Publication No. 2013-12198).

However, in the past, the user, although be informed of information related to the reuse of paper (the number of reused paper or the decreased number of paper), cannot be informed of information (e.g. rejection cost) of paper which are not reusable and to be rejected, thus, the user cannot be informed of how many contributions the user can make to protect environment by decreasing the rejection amount.

### BRIEF DESCRIPTION OF THE DRAWINGS

FIG. 1 is a system configuration diagram illustrating a network system provide with an environmental protection supporting apparatus according to an embodiment;

FIG. 2 is a configuration diagram illustrating the specific configuration of an erasing apparatus according to an embodiment;

FIG. 3 is a block diagram illustrating the control system of an erasing apparatus according to an embodiment;

FIG. 4 is a block diagram illustrating the configuration of a management server serving as an environmental protection supporting apparatus according to an embodiment;

FIG. 5 is a diagram illustrating the erasing log data stored in a database according to an embodiment; and

FIG. 6 is a flowchart illustrating the processing of a management server according to an embodiment.

### DETAILED DESCRIPTION

In accordance with an embodiment, an environmental protection supporting apparatus comprises a storage section configured to store, based on the result of an erasing processing of heating a recording medium on which an image is formed with a color erasable coloring agent to erase the image formed thereon, the erasing log of the recording medium which is at least determined as reusable; a rejection information generation section configured to generate, based on the erasing log, rejection information obtained from the rejection of the reusable recording medium as environmental load reduction information; and a presenting section configured to display the environmental load reduction information on a display section.

Embodiments of the present invention are described in detail below with reference to the accompanying drawings, in each of which identical components are denoted by identical reference signs.

### Embodiment 1

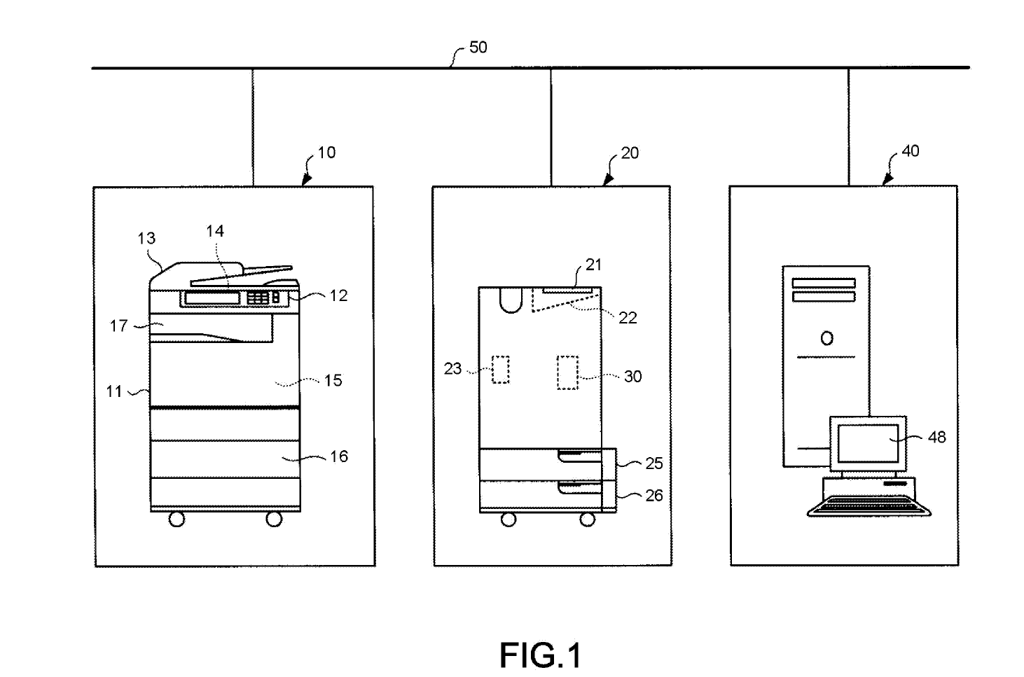

FIG. 1 is a system configuration diagram illustrating a network system provide with an environmental protection supporting apparatus involved in the embodiment 1. The network system shown in FIG. 1 comprises a digital compound machine 10 (hereinafter referred to as MFP: Multi-function Peripheral for short) serving as an image forming apparatus, an erasing apparatus 20 and a management server 40 and the like. The MFP 10, the erasing apparatus 20 and the management server 40, each of which has a data communication function, are connected with each other via a network 50 such as a LAN (Local Area Network). The network 50 may be also realized through wireless communication.

The MFP 10 has a scanner function, a printer function, a network communication function and the like; an operation panel 12, an ADF (automatic document feeder) 13 and a scanner (image reading section) 14 are arranged on the upper portion of the main body 11 of the MFP; a printer (image forming section) 15 is arranged in the center of the main body 11; and a paper cassette 16 is arranged on the lower portion of the main body 11.

With the operation pane 12 including an operation section consisting of various keys and a touch panel type display section, ‘number of copies’, ‘number of print copies’, ‘paper size’ and the like can be input. The scanner section 14 reads an original document fed by the ADF 13 or an original document placed on an original table to generate image data. The printer section 15 including a photoconductive drum and laser processes the image data read by the scanner section 14 and the image data generated in a PC (Personal Computer) and the like and fixes an image on a paper serving as a recording medium. The paper on which an image is fixed by the printer section 15 is discharged to a paper discharging section 17. Paper and OHP sheet can serve as the recording medium, and paper is described below as an example of the recording medium.

The MFP 10, which may carryout an image forming processing using a color erasable coloring agent which undergoes a chemical reaction when heated to a given temperature and is consequentially color-erased and a color inerasable coloring agent the color of which is not erased even the color inerasable coloring agent is heated to a given temperature, forms an image with a color erasable coloring agent in the reuse of a paper. Further, the dyes such as leuco dye can be used as the color erasable ink, that is, the color erasable coloring agent. The color of the color erasable ink is erased when the color erasable ink is heated to, for example, about 180-200 degrees centigrade.

On the other hand, the erasing apparatus 20 comprises an operation panel 21, a paper feed section 22, a scanner 23 serving as a reading section and an erasing section 30. Further, the erasing apparatus 20 comprises a first paper discharging tray 25 and a second paper discharging tray 26 (reject box).

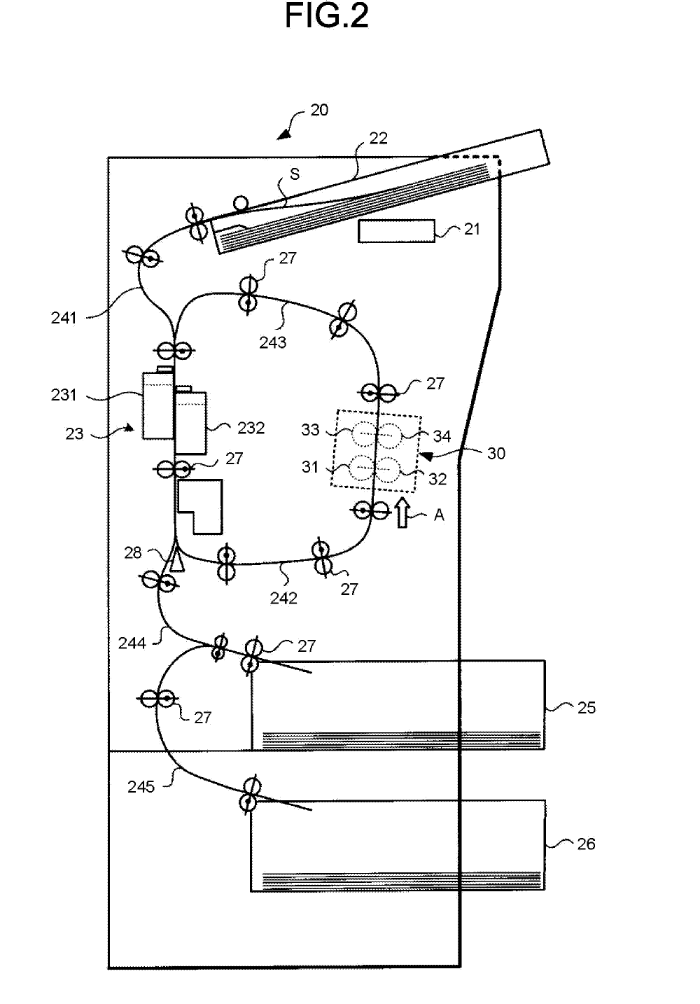

FIG. 2 is a configuration diagram illustrating the specific configuration of the erasing apparatus 20. In FIG. 2, the erasing apparatus 20 comprises the operation panel 21 provided with operation keys and a display section, the paper feed section 22, the scanner 23 and the erasing section 30. The erasing apparatus 20 further comprises: a first to a fifth conveyance paths 241-245, the first paper discharging tray 25 and the second paper discharging tray 26 (reject box).

A plurality of motor-driven conveyance rollers 27 are arranged on each of the conveyance paths 241-245 to convey paper. Further, a gate 28 is arranged to distribute the conveyance of paper towards the conveyance path 242 and the conveyance path 244.

The first conveyance path 241 conveys a paper S from the paper feed section 22 to the scanner 23. The second conveyance path 242 conveys the paper S from the scanner 23 towards the erasing section 30 along the direction indicated by an arrow A. The third conveyance path 243 conveys the paper S from the erasing section 30 to the scanner 23 again. The fourth conveyance path 244 conveys the paper S from scanner 23 to the first paper discharging tray 25. The fifth conveyance path 245 conveys the paper S from scanner 23 to the reject box 26. The first paper discharging tray 25 collects, for example, a paper which becomes reusable after the image formed on the paper is erased. The reject box 26 collects a paper (not-reusable paper) which is hardly reusable and usually to be rejected and recycled.

The erasing apparatus 20 shown in FIG. 2 substantially carries out the following erasing processing.

First, a color-erasing and reading mode is selected by the operation section 21 for a paper S, the paper S is fed from the paper feed section 22 and then conveyed along the first conveyance path 241 to the scanner 23 serving as a reading section. The scanner 23 scans an image and reads image data before the color of the image on the paper S is erased. Further, the printing ratio of the paper S is calculated. The scanner 23 includes a first scanner 231 and a second scanner 232 to read two sides of the paper S. The scanner 23 further reads the printing condition of the paper S.

A paper S which is determined to be ripped or crumpled according to the printing condition read by the scanner 23 and is therefore determined as not reusable is guided to the fifth conveyance path 245 and conveyed to the reject box 26. Further, a paper of a high printing ratio, which is likely to curl in an erasing processing, is determined as not reusable and then conveyed to the reject box 26. A paper without any rip or crumple is conveyed to the erasing section 30 through the second conveyance path 242.

The paper S conveyed to the erasing section 30 is heated when passing through the erasing section 30 to thermally erase the image formed on the paper S. The erasing section 30 heats and pressurizes the paper S at a high temperature of 280-300 degrees centigrade so as to erase the color of the image on the paper S. That is, the image is formed on the paper S with a color erasable coloring agent the color of which is erased when the color erasable coloring agent is heated to a given temperature. Thus, the color of the paper S can be erased by conveying, at a preset conveyance speed, the paper S through the erasing section 30 which heats the paper at a given temperature.

The paper S passing through the erasing section 30 is conveyed to the scanner 23 again via the third conveyance path 243. The scanner 23 reads the printing condition again to confirm whether or not the color of the image formed with the color erasable coloring agent is reliably erased and distinguishes the paper S.

The paper S which is determined to be reusable since the image thereon is erased according to the reading result of the scanner 23 is conveyed to the first paper discharging tray 25 via the fourth conveyance path 244. Further, a paper S which is determined to be not-reusable since the paper is ripped or crumpled in addition to that there is a residual image formed with a color inerasable coloring agent or a handwritten image left in the image area of the paper according to the printing condition read by the scanner 23 is conveyed to the reject box 26 via the fifth conveyance path 245.

The erasing section 30 includes a first erasing section provided with a heat roller 31 and a press roller 32 and a second erasing section provided with a press roller 33 and a heat roller 34, and paper S are conveyed and heated between the heat roller 31 and the press roller 32 and between the press roller 33 and the heat roller 34. Heat sources are arranged inside the heat rollers 32 and 34, respectively, and temperature detection sections are arranged on the outer periphery of the heat rollers 32 and 34, respectively. The heat source may be, for example, a lamp.

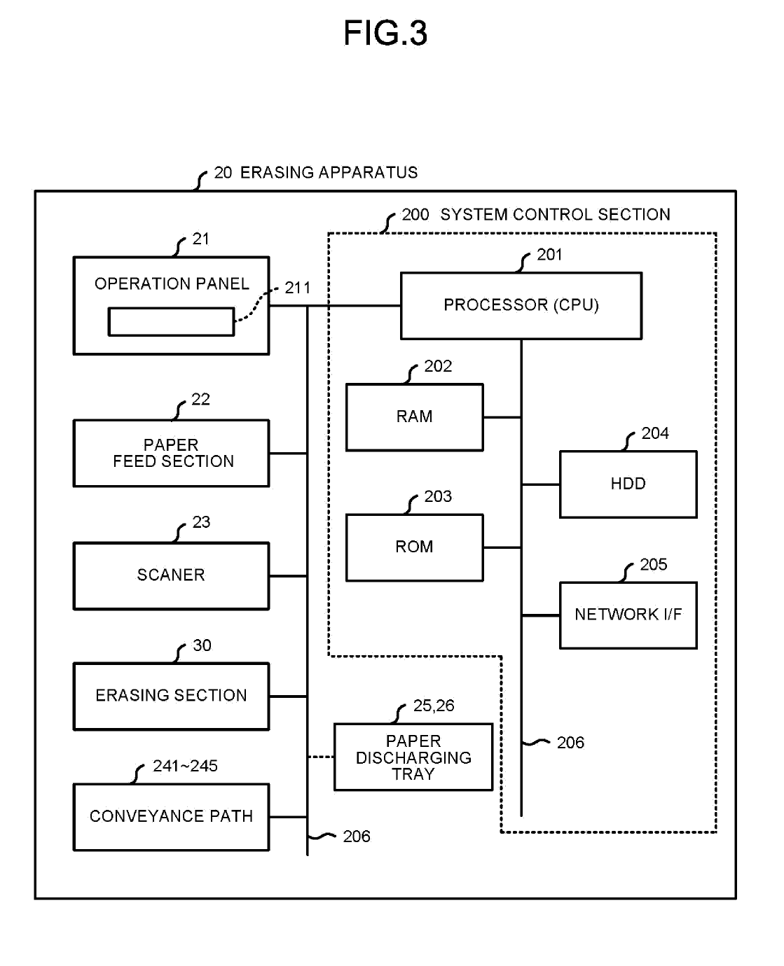

FIG. 3 is a block diagram illustrating the control system of the erasing apparatus 20. The erasing apparatus 20 comprises a system control section 200 for controlling each part collectively. The system control section 200 controls, for example, the operation panel 21, the paper feed section 22, the scanner 23, the erasing section 30 and the first to the fifth conveyance paths 241-245. Further, a reusable paper is discharged to the first paper discharging tray 25, and a rejected not-reusable paper is discharged to the second paper discharging tray 26 (reject box).

The system control section 200 includes, for example, a CPU 201 serving as a controller, a RAM (random access memory) 202, a ROM (read only memory) 203, a HDD (hard disk drive) 204 and a network interface (I/F) 205, each of which is connected with each other via a bus line 206.

The CPU 201 realizes various processing functions by executing the control programs stored in the ROM 203. The RAM 202 is a main memory functioning as a working memory. The ROM 203 stores the control program and control data for controlling operations of the erasing apparatus 20 and realizing various processing functions. For example, the ROM 203 stores determination level information indicating whether to reuse a paper or reject a paper and the set temperature information of the erasing section 30, and the CPU 201 distinguishes between reusable paper and not-reusable paper based on the image erasing result of the erasing section 30.

The HDD 204 is a high-capacity storage memory capable of storing various kinds of data and information. The network interface (IF) 205 is an interface for communicating with the NFP 10, the management server 40 or other external apparatuses (e.g. PC) via the local area network 50.

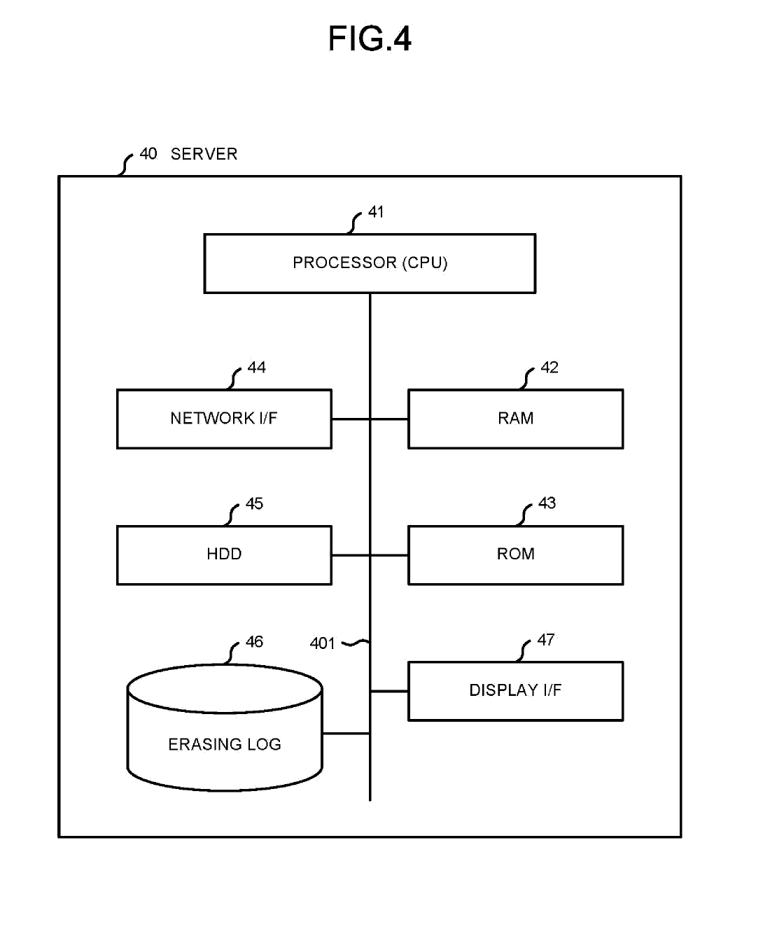

FIG. 4 is a block diagram illustrating the management server constituting an environmental protection supporting apparatus. The management server 40 comprises, for example, a CPU 41 serving as a controller, a RAM 42, a ROM 43, a network interface (I/F) 44, a HDD 45, a database 46 and a display I/F 47, which are connected with each other via a bus line 401.

The CPU 41 controls the whole management server 40 and realizes various functions relating to the support for environmental protection by executing the programs stored in the ROM 43. The RAM 42 is a working memory. The control program and control data and the like for controlling basic operations of the server 40 is stored in the ROM 43.

The network interface 44, which is an interface for the data communication with each apparatus (MFP 10, erasing apparatus 20 and the like) connected to the LAN 50, includes an input section, such as a keyboard or a mouse, for inputting various data and instructions. The HDD 45 is a memory device for data storage. For example, data for user authentication is stored in the HDD 45.

In the management server 40, the CPU 41 has a user authentication function. With the user authentication function, the user information, such as a user ID or a password, input by a user using the operation panel 12 of the MFP 10 or the operation panel 21 of the erasing apparatus 20 can be acquired. Further, when the user belongs to a specific department, the user authentication may be a department authentication.

The user authentication function determines whether or not an authentication is succeeded by comparing the user information acquired from the MFP 10 or the erasing apparatus 20 with the data stored in the HDD 45 for user authentication. Further, user information for user authentication may also be read from the IC card held by a user using the MFP 10 or the erasing apparatus 20.

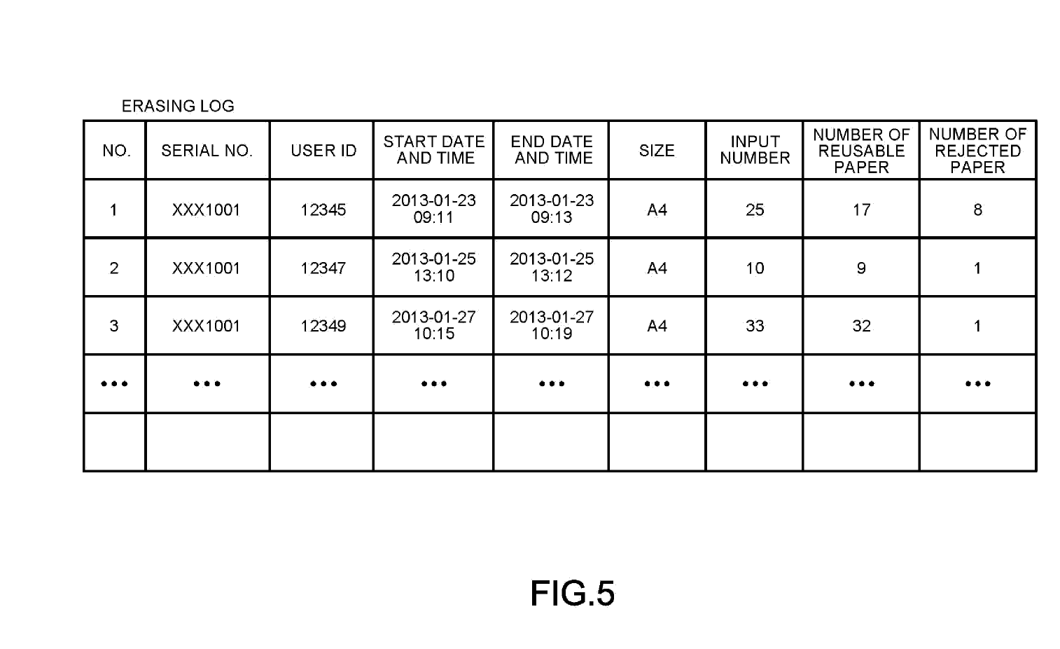

Moreover, a conversion table for calculating the cost on the rejection of paper discharged to the reject box 26 from the erasing apparatus 20 is stored in the HDD 45. Further, the database 46 constitutes a storage section for storing the erasing log (will be described later) shown in FIG. 5. The CPU 41 communicates with the MFP 10 and the erasing apparatus 20 via the network I/F 44 to, for example, collect data related to an erasing condition regularly from the erasing apparatus 20 and store the erasing log in the database 46. The display I/F 47 which is an interface for the connection with a display gives the display a prompt regarding display data such as the under-mentioned paper rejection information.

FIG. 5 is a table showing the erasing log data stored in the database 46. The erasing log is a log resulting from the regular collection of erasing-related data from the erasing apparatus 20. In the case where a plurality of erasing apparatuses 20 are connected with the network 50, the database 46 stores erasing logs aiming at each erasing apparatus.

FIG. 5 shows an example of the erasing log. The erasing log includes: ‘serial number’ representing the machine body of an erasing apparatus, ‘user ID’ for identifying a user, ‘start date and time’ and ‘end date and time’ representing the implementation time of an erasing processing, ‘size’ representing the size of a paper for which an erasing processing is carried out, ‘input number’ representing a paper number set in an erasing apparatus and the result of an erasing processing, which is indicated by ‘the number of reusable paper’ representing the number of reusable paper and ‘the number of rejected paper’ representing the number of the paper which are determined as not reusable as the color thereof cannot be erased. Here, rejected paper includes a paper having a residual image thereon since the image thereon cannot be totally erased and a ripped or crumpled paper.

For example, the erasing log No. 3 shown in FIG. 5 represents that a user ‘12349’ sets that an erasing processing is carried out for 33 A4-size paper in the erasing apparatus the machine body number of which is ‘XXX1001’ during the period from 10:15, January 27 to 10:19, January 27 in 2013. The result of the erasing processing shows that images of 32 reusable paper are erased and 1 paper is rejected.

Next, environmental protection supporting operations carried out in an embodiment are described.

In the embodiment, the rejection information, for example, the rejection cost, of paper to be rejected is calculated based on the erasing log stored in the database 46 of the server 40 and presented to the user. That is, the reuse of a paper by erasing the image formed on the paper using the erasing apparatus 20 is beneficial to environmental protection, and in the case where a paper is not reusable and to be rejected, a rejection cost is presented to the user to strengthen the environmental awareness of the user. Rejection information of paper to be rejected is generated by the CPU 41.

For example, when the recycle of paper which is to be rejected after being determined as not reusable is collected by a reject collector, it incurs a transporting cost and the like. Further, even the burning of rejected paper gives rise to a transporting cost as well. Thus, the CPU 41 determines the number of the paper to be rejected and calculates a total rejection cost by multiplying the rejection cost of each paper by the number of paper to be rejected. The rejection cost of each paper is calculated according to a communication cost (the communication cost on contacting a reject collector), a reject paper transporting cost and other kinds of data.

The HDD 45 of the server 40 stores the data of the rejection cost of each reject paper (conversion table), and the CPU 41 can calculate paper rejection cost as long as the CPU 41 can obtain the total number of paper to be rejected. The conversion table pre-stores, for example, the rejection cost (e.g. 0.01 $ per paper) of each A4 paper and on this basis, calculates the rejection cost of each A3 paper by doubling the rejection cost of each A4 paper.

Thus, the CPU 41 can calculate a rejection cost by reading the size and the number of reject paper from the erasing log in the database 46. Further, in addition to the rejection cost of each paper, the rejection cost of each gram of paper may also be stored in the conversion table to calculate a total rejection cost by multiplying a total reject weight corresponding to the number of rejected paper by the rejection cost of each gram of paper.

Further, the rejection cost may also be deemed as environmental load reduction information. That is, the rejection of paper is accompanied by a transportation-related environmental load, and the burning of paper gives rise to an environmental load due to the generation of carbon dioxide. The reuse of paper can prevent the occurrence of the aforementioned environmental load. Thus, if the rejection cost or reject weight of paper which are reusable but rejected can be calculated by the CPU 41, then the result of the calculation can be indicated as environmental load reduction information. In this case, the CPU 41 becomes a rejection information generation section which generates, based on the erasing log in the database 46, rejection information obtained from the rejection of a reusable recording medium as environmental load reduction information.

The calculated rejection cost is displayed on a display 48 (FIG. 1) via the display I/F 47. Further, as to the erasing logs, the erasing logs may be collected aiming at each user, as shown in FIG. 5, or aiming at each department or each office. Thus, the rejection information can be presented according to each office, each department or each user. Besides, the rejection information may be presented the day an erasing processing is carried out or every a given period of time such as a week or a month.

How much rejection cost is spent by each department or each user can be known by viewing the presented rejection information, and the reuse rate of paper can be increased if the rejection cost is reduced by urging the department or user to print with a color erasable ink. Further, apart from a rejection cost, the number and the weight of the paper to be rejected may also be presented. The smaller the number or weight of the paper to be rejected is, the more contributions the user makes to protect environment, thereby realizing a further reduction in the rejection cost. Further, as the rejection cost on the rejection of reusable paper can be calculated and displayed as environmental load reduction information, how much environmental load is decreased can be known.

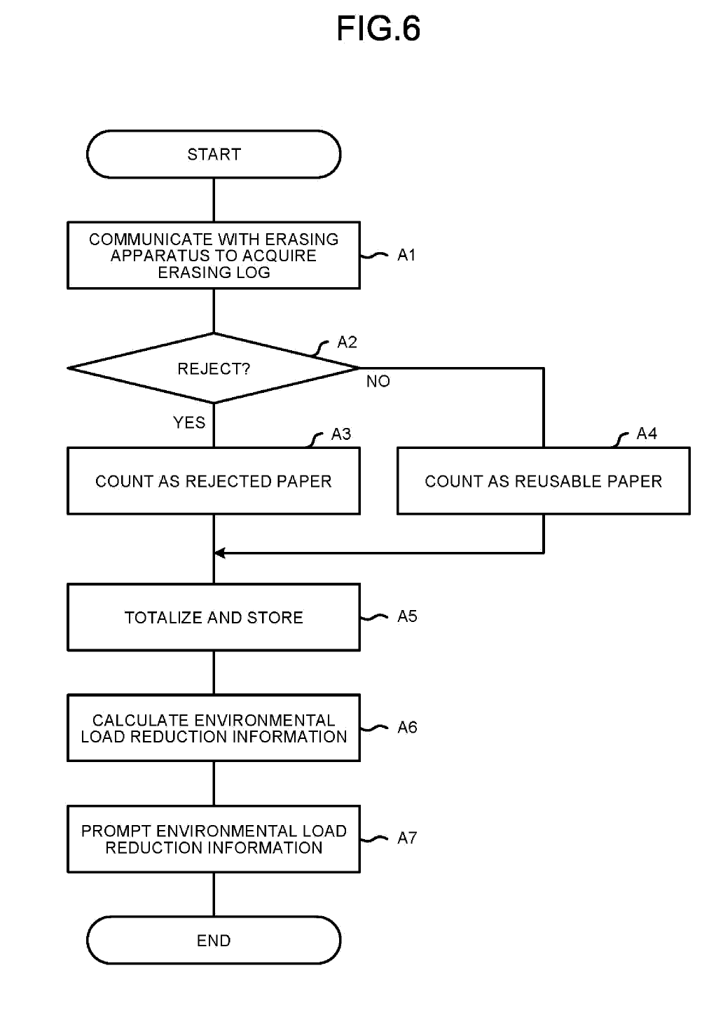

FIG. 6 is a flowchart illustrating the processing of the management server 40. In FIG. 6, the CPU 41 communicates with the erasing apparatus 20 to acquire an erasing log (Act A1). The CPU 41 determines whether or not a paper is a reject paper (Act A2). That is, the CPU 41 determines whether a paper is a reject paper or a reusable paper. As the collected erasing log contains the information of the result of a determination on a reusable paper the color of which is erased by the erasing apparatus 20 or a reject paper (not reusable), the CPU 41 can make a determination in Act A2.

If the CPU 41 determines that the paper is a reject paper in Act A2, then the CPU 41 counts the paper as a rejected paper (Act A3). Further, if the CPU 41 determines that the paper is not a reject paper in Act A2, then the CPU 41 counts the paper as a reusable paper in Act A4.

After Act A4, the CPU 41 totalizes the result of the counting and stores the erasing log in the database 46 (Act A5). Here, the result of the counting of the CPU 41 in Act A3 is totalized as ‘the number of reject paper’, and the result of the counting of the CPU 41 in Act A4 is totalized as ‘the number of reusable paper’.

Further, based on the conversion table stored in the HDD 45, the CPU 41 calculates a rejection cost according to the rejection cost of each paper and the total number of reject paper. Further, the CPU 41 converts the rejection cost to environmental load reduction information.

Next, in Act A7, the CPU 41 instructs the display of the environmental load reduction information calculated in Act A6 on the display 48 via the display I/F 47. The display I/F 47 is also a presenting section for displaying the environmental load reduction information on the display section (display) 48.

The totalized number of reject paper can be deemed as the number of the paper which are not reusable and to be rejected. Thus, by totalizing the number of reject paper, the cost on the rejection of paper can be presented in an environment such as an office. Further, if a rejection cost on the rejection of reusable paper is calculated and displayed by totalizing reusable paper, then environmental load reduction information can be presented.

As the erasing log collected from each erasing apparatus is stored and totalized in the database 46 of the server 40, the rejection information (rejection cost) and environmental load reduction information can be presented to the user according to each office, each department and each user.

According to the aforementioned embodiment, rejection information of not-reusable (preset to be rejected) paper can be obtained by collecting erasing logs from an erasing apparatus. Thus, a rejection cost can be calculated and presented to the user, and the user can be urged to reuse paper if the rejection cost increases significantly.

In addition, in the aforementioned embodiments, the server 40 is exemplified as an environmental protection supporting apparatus, however, the present invention is not limited to this, the erasing apparatus 20 or the MFP 10 may have some functions of the management server 40 (e.g. the database 46 for storing erasing logs or the display I/F 47) or all the functions of the management server 40. For example, if a display section 211 is arranged on the operation panel 21 of the erasing apparatus 20 (FIG. 3) and the functions of the management server 40 are provided in the erasing apparatus 20, then rejection information of not-reusable paper can be displayed on the erasing apparatus 20. Alternatively, the functions of the erasing apparatus 20 may be provided in the MFP 10.

In the embodiments, any of the processes described above can be accomplished by a computer-executable program, and this program can be embodied in a non-transitory computer-readable memory device. In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above. Furthermore, based on an instruction in the installed program, an OS (operating system) of the computer, or MW (middleware software), such as database management software or network, may execute one or more parts of the processes described above to realize the embodiments.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An environmental protection supporting apparatus, comprising:
a storage section configured to store, based on the result of an erasing processing of heating a recording medium on which an image is formed with a color erasable coloring agent to erase the image formed thereon, the erasing log of the recording medium which is at least determined as reusable;
a rejection information generation section configured to generate, based on the erasing log, rejection information obtained from the rejection of the reusable recording medium as environmental load reduction information; and
a presenting section configured to display the environmental load reduction information on a display section.

2. The environmental protection supporting apparatus according to claim 1, wherein
the rejection information generation section generates the rejection cost on the rejection of the reusable recording medium as environmental load reduction information.

3. The environmental protection supporting apparatus according to claim 1, comprising:
a paper discharging tray to which the reusable recording medium is discharged, wherein
the rejection information generation section generates the environmental load reduction information according to the number of the recording mediums discharged to the paper discharging tray.

4. A supporting method for the erasing of an image formed on a recording medium with a color erasable coloring agent through heating the recording medium, comprising:
storing, based on the result of the erasing processing, the erasing log of the recording medium which is at least determined as reusable;
generating, based on the erasing log, rejection information obtained from the rejection of the reusable recording medium as environmental load reduction information; and
displaying the environmental load reduction information on a display section.

5. The supporting method according to claim 4, wherein
with the rejection information generation function, the rejection cost on the rejection of the reusable recording medium is generated as environmental load reduction information.
